(19) United States
(12) Patent Application Publication
(10) Pub. No.: US 2007/0016468 A1
(43) Pub. Date: Jan. 18, 2007

(54) System, medium, and method for guiding election campaign efforts

(76) Inventors: Michael Edward Campbell, Stillwater, MN (US); John W. Bell, Chanhassen, MN (US); Cullen D. Sheehan, Johnston, IA (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/483,938

(22) Filed: Jul. 10, 2006

Related U.S. Application Data
(60) Provisional application No. 60/698,727, filed on Jul. 13, 2005.

(51) Int. Cl. G07C 13/00

(52) U.S. Cl. 705/12

(57) ABSTRACT

A computer-readable medium having computer-executable instructions useful in guiding election campaign efforts includes vote data of ballots cast in an election collected from at least one data source, a database, and an array of operand manipulative cells electronically communicating with the database. The vote data are compiled on a first level, and the database includes at least one dataset of cells formatted to include the vote data compiled on the first level. The array of operand manipulative cells electronically communicate with the database and are operable to produce a subset of synthesized voter data compiled on a second level that is derived from the vote data points compiled on the first level.

### CROSS-REFERENCE TO RELATED APPLICATIONS

This Non-Provisional Utility patent application claims the benefit of the filing date of U.S. Provisional Patent Application Ser. No. 60/698,727, filed Jul. 13, 2005, entitled “SYSTEM AND METHOD OF GUIDING ELECTION CAMPAIGN EFFORTS,” which is incorporated herein by reference.

### FIELD OF THE INVENTION

The present application relate to systems, computer mediums, and methods useful in guiding election campaign efforts.

### BACKGROUND

The government, and other sources, collects a huge volume of voter data. The government has an interest in collecting the data to inform the electorate of the outcome of elections, and to ensure that elections are conducted in a procedurally correct manner. However, for a wide variety of reasons, the data as collected are not in forms that are useful for data analysis. In fact, the volume of voter data that is typically collected for a state or national election is so large that the size of the dataset alone impedes meaningful analysis. For example, voter data are typically collected in fragmented bits (such as a single vote cast for a single candidate) and stored in various fragmented fields (such as votes cast in a precinct). While this fragmented (and huge) dataset might provide a “big picture” snapshot of the election results, it is almost useless for analytical purposes.

With the above in mind, those who manage election campaigns have an interest in managing their campaign wisely to ensure that scarce resources are best directed to the portion of the electorate that is likely to be persuaded by the campaign message. In particular, it is generally recognized that a campaign is not likely to change the position of voters who are generally opposed to the campaign message, especially in a two party system. Thus, election campaigns have a desire to target campaign resources to receptive voters, and limit or eliminate the expenditure of campaign resources to those voters who are not receptive to the campaign message.

For the above reasons, improvements and advances in guiding the expenditure of campaign resources directly to the voters most likely to support the campaign will be welcomed by those who are active in shaping free and democratically elected governments.

### SUMMARY

Aspects of the present invention provide a useful and tangible result by guiding and targeting election campaign efforts to precincts, counties, and/or congressional districts where voter proclivities are known and/or predictable based upon actual prior ballots cast. Thus, future campaign efforts and resources can be directed to voters who have shown past support for a given candidate/party without expending resources on voters who have shown past support a different candidate/party. The practical utility of aspects of the present invention include producing synthesized voter data that is compiled on a level that is useful for data analysis that enables accurate prediction of future vote data.

One aspect of the present invention provides a computer-readable medium having computer-executable instructions useful in guiding election campaign efforts. The computer-readable medium includes vote data of ballots cast in an election collected from at least one data source, a database, and an array of operand manipulative cells electronically communicating with the database. The vote data are compiled on a first level, and the database includes at least one dataset of cells formatted to include the vote data compiled on the first level. The array of operand manipulative cells electronically communicate with the database and are operable to produce a subset of synthesized vote data compiled on a second level that is derived from the vote data points compiled on the first level.

Another aspect of the present invention provides a method of guiding election campaign efforts. The method includes extracting voter data of actual ballots cast in an election and disseminated by a data source, the voter data including votes compiled at a first level. The method additionally includes formatting the votes compiled at the first level into at least one dataset of cells within a database. The method further includes electronically manipulating the dataset(s) of cells with an array of operand manipulative cells to produce synthesized voter data formatted on a second level that is at least as large as the first level.

Another aspect of the present invention provides an election campaign management system. The system includes a computer system and a program operable by the computer system. In this regard, the program includes historical data of votes cast by precinct in an election collected from a data source, a database, and an array of operand manipulative cells electronically communicating with the database. The database includes at least one dataset of cells formatted to include the historical data of votes cast by precinct. The array of operand manipulative cells electronically communicate with the database and are operable to produce a subset of synthesized voter data compiled on a second level that is derived from the historical data of votes cast by precinct.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 illustrates a flow diagram of an algorithm employed to guide election campaign efforts according to one embodiment of the present invention;

FIG. 2 illustrates a government source of fragmented delineated historical voter data of actual ballots cast in an election according to one embodiment of the present invention;

FIG. 3 illustrates fragmented/delineated historical voter data of actual ballots cast in an election at a precinct level for a county as collected by a government source;

FIG. 4 illustrates the historical voter data compiled into a database of a logical data retrieval system (a computer program) that includes an array of operand manipulative cells that electronically communicate with the historical voter data in the database according to one embodiment of the present invention;

FIG. 5A illustrates the logical data retrieval system of FIG. 4 manipulated to produce synthesized voter data for all precincts in a municipality of a county relative to a selected candidate according to one embodiment of the present invention;

FIG. 5B illustrates a map representing a portion of the synthesized voter data of FIG. 5A;

FIG. 6 illustrates a flow diagram of an algorithm for guiding election campaign efforts according to another embodiment of the present invention;

FIG. 7 illustrates a flow diagram of an algorithm for guiding election campaign efforts according to another embodiment of the present invention; and

FIG. 8 illustrates an election campaign management system according to one embodiment of the present invention.

### DETAILED DESCRIPTION

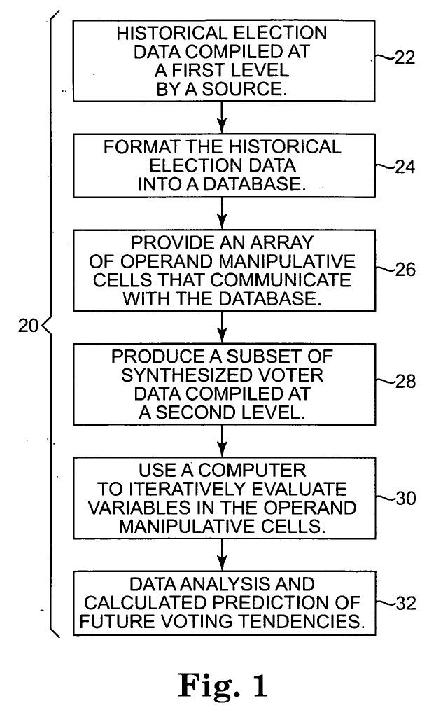

FIG. 1 illustrates a flow diagram of an algorithm 20 employed to guide election campaign efforts according to one embodiment of the present invention. The algorithm 20 and other components of the present invention can be implemented in hardware via a microprocessor, programmable logic, or state machine, in firmware or in software with accessed by an electronic device, such as a computer. In one aspect, at least a portion of the software is web-based and written in Hyper Text Mark-up Language (HTML) and/or Java programming languages, including links to user interfaces for data collection, such as a Windows-based operating system. Each of the main components may communicate via a network using a communication bus protocol. For example, the present invention can be implemented using a Transmission Control Protocol/Internet Protocol (TCP/IP) suite for data transport. Other programming languages and communication bus protocols suitable for use with the present invention will be apparent to those skilled in the art after reading this disclosure.

In other embodiments, components of the present invention may reside in software on one or more computer-readable mediums. The term “computer-readable medium” as used herein is defined to include any kind of memory, whether volatile or non-volatile, and available via floppy disk, hard disk, compact disk (CD), flash memory device, read-only memory (ROM) device, CD-ROM, and random access memory (RAM) device.

In this application, the term “hyperlink” is defined to be an element in an electronic document that links to another place/location in the same document, or to an entirely different document. Hyperlink as used herein includes hypertext systems as used on the Internet.

The term “operand” is defined to be any object, numerical or otherwise, that is manipulated by an operator.

An “operator” is defined to be any mathematical symbol or function that acts on an operand.

The term “spreadsheet” is defined to be a table of values, where each value can have a pre-defined relationship to other values. A spreadsheet application is a computer program that electronically manipulates one or more spreadsheets.

The term “compile” is defined to include integrating or otherwise assembling data or other information into a composite whole that is larger than a subset of the data that forms the composite whole.

The algorithm 20 provides at 22 historical election data compiled at a first level by a source. The historical election data can include votes corresponding to a particular candidate, votes for all candidates of a party, votes for multiple candidates, including write-in candidates, and the historical election data can be collected on a scale ranging from one vote cast in the smallest of precincts to all votes cast in a national election, for example.

In one embodiment, the historical election data represents actual ballots cast in an election as recorded by a government entity, such as a Secretary of State. In this regard, the historical election data collected from the government entity is said to be fragmented because the government entity provides the election data in a format suited to record and inform to the electorate, but the government source does not provide the raw historical election data in a format suitable for data analysis. In other words, the government provides a huge volume of delineated election data that is not in a useable analytical form.

The algorithm 20 provides at 24 formatting the historical election data into a database. In one embodiment, the database is a multi-dimensional database, as described below, and the historical election data are formatted into a dataset of cells provided on at least one level, or dimension, of the database. To this end, the algorithm 20 provides at 24 formatting the historical election data into a useable analytical form, which can include converting the fragmented data into useable (i.e., searchable) text data, for example, and integrating and/or assembling the useable data into the database.

The algorithm 20 at 26 provides an array of operand manipulative cells that communicate with the database that contains the converted historical election data. In this regard, operand manipulative cells are configured to manipulate one or more of the dataset of cells based upon, for example, a query submitted by a user. Targeted election information useful to campaign management can be derived by manipulating the dataset of cells with appropriate queries, or an appropriate range of queries.

The algorithm 20 provides at 28 producing a subset of synthesized voter data compiled at a second level. In this regard, the synthesized voter data are output data derived from the queries, and is compiled at a level that is related to a desired output of the query. For example, in one embodiment the synthesized voter data includes all precincts in a state (i.e., this is the level to which the data are compiled) in which a given candidate receives 50% or more of the votes (i.e., this is the synthesized voter data) cast in an election for that office.

The algorithm 20 provides at 30 using a computer to iteratively evaluate variables in the operand manipulative cells. Ultimately, the algorithm 20 provides at 32 data analysis and a calculated prediction of future voting tendencies, both of which are useful in managing election resources.

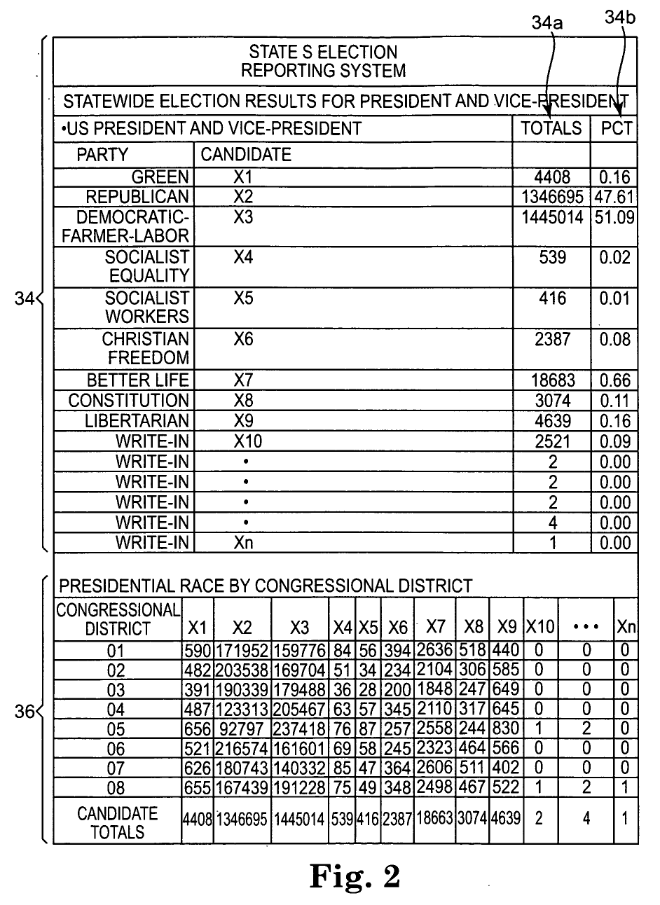

FIG. 2 illustrates historical election data of actual votes cast on ballots in the 2004 general election as reported by the Secretary of State for state S. In this regard, data related to actual votes cast in an election can be disseminated by more than one source (even private sources), although since each state is required by law to disseminate election results, one embodiment provides acquiring historical election data as reported by the Secretary of State for any one (or all) state(s). In one embodiment, field 34 is a data field that presents statewide election results collected on a precinct level for each candidate, and field 36 is a data field that presents historical voter data of actual ballots cast on the precinct level in the presidential race and grouped by congressional district for the state of Minnesota. In this regard, FIG. 2 is an illustrative example, and it is to be understood that the historical election data can be presented by the source/government entity in one or more fields.

Field 34 provides statewide election results by party and candidate. Column 34a provides a total number of votes cast for each candidate of each party. Column 34b provides a percentage that each candidate received relative to the number of total votes cast.

With regard to field 34, state S provides statewide election results for multiple political parties. For example, under the heading of “Party” in field 34 is a list of multiple political parties each having at least one candidate in the race, in addition to multiple write in candidates submitted by members of the electorate. In this regard, historical election data are provided for multiple candidates X1, X2, X3 . . . Xn in this exemplary set of statewide election results. In other words, a government source (i.e., state S) has collected and disseminates to the public election results of each vote cast for each candidate X1, X2, X3 . . . Xn. As a point of reference, the vote totals represented in column 34a represent the sub-total of all votes cast for all polling places in state S.

Field 36 provides election results for the presidential race by congressional district. State S has eight (8) congressional districts. In this regard, field 36 represents the total votes cast for each candidate X1, X2, X3 . . . Xn as collected in all precincts reporting in the eight congressional districts. With this in mind, field 36 is a different representation of the vote data that appears in column 34a in field 34. That is to say, field 36 represents a greater number of data points than field 34 (i.e., a congressional district is larger in size than a precinct within the congressional district), but a summation of the data in field 36 equates to the data represented in field 34, specifically in column 34a.

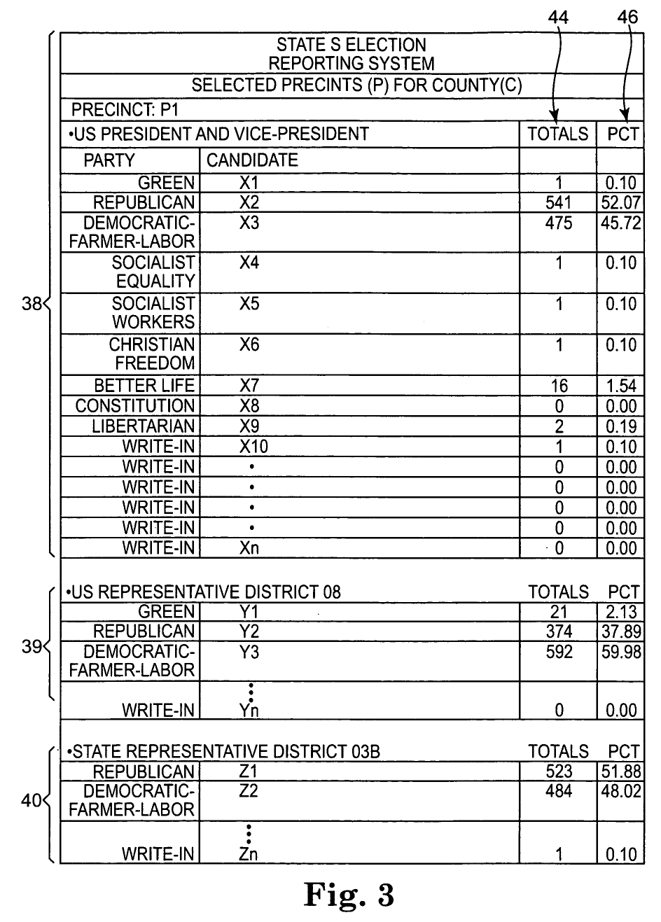

FIG. 3 illustrates voter data recorded at a precinct (P) level for one county (C) as collected by a government source according to one embodiment of the present invention. One selected precinct represented by P1 is illustrated for one county C. Candidates X1, X2, X3 . . . Xn are each associated with their respective political party. Field 38 provides a listing of political party and candidate (X1, X2, X3 . . . Xn) for the U.S. president and vice presidential race. Column 44 represents the total number of votes for each candidate in precinct P1 of county C for state S. In this regard, a typical state will have thousands of precincts reporting voter data. As one example, the state of Minnesota recorded vote data for the 2004 general election that included ballots cast in 4,108 precincts. Therefore, the data represented in field 38 (collected on the precinct P1 level) represents only a small amount of the total data available for the entire state S.

Field 39 provides vote totals by party and candidate Y1, Y2, Y3 . . . Yn for U.S. Representative in District 08 of state S. Field 40 provides vote totals for each candidate Z1, Z2, Z3 . . . Zn for each political party in the state representative election race in District 03B.

With reference to FIGS. 2 and 3, it is to be appreciated that the historical election data of actual ballots cast as collected by a representative governmental source (for example the Secretary of State of state S) is accurate and voluminous, but of limited utility for those who might wish to extract data from the source and manage a political campaign. For example, the data in fields 34-40 documents the number of actual votes cast for each candidate, but the fields 34-40 are wholly unrelated to other votes cast for other candidates (in the same or in a different political party) in other elections in state S, or in other states. Specifically, the predictive value of the data in fields 34-40 are acutely limited and offer only a historical “snapshot” of votes cast for a particular candidate in a particular precinct of a particular county.

As one example, the data in column 44 is also available for other precincts. Added together, the precinct data will reflect a total number of votes cast for candidate X2, for example. However, because the data are presented on a precinct level (when viewed at the Secretary of State website, for example), it is difficult if not impossible to gain a view of how many votes candidate X2 received in a large city, or in a region, or along an interstate corridor within state S. Thus, although the data illustrated in FIGS. 2 and 3 are accurate and interesting, this historical election data of actual ballots cast is of limited predictive value. In addition, data illustrated in FIGS. 2 and 3 are disseminated in a delineated form of some sort, such as tab delineated, or colon delineated, or semi-colon delineated, and as such, is disseminated by the source in a format that is suitable primarily for viewing.

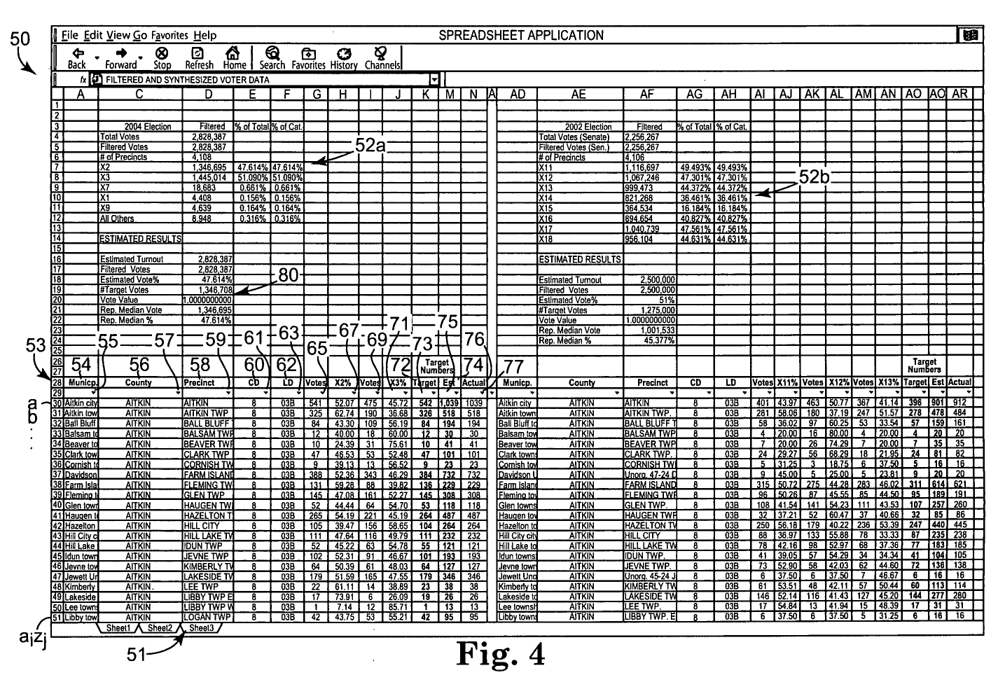

Algorithm 20 (FIG. 1) of a method of guiding election campaign efforts provides at 24 for formatting the delineated data into a useable form. For example, the historical election data of actual ballots cast (fields 34-40 in FIGS. 2-3) can be deconstructed/correlated such that all of the actual votes cast are formatted to associate with a particular precinct of a particular municipality of a particular county in a particular state where the ballot was cast. For example, in one embodiment the data represented in fields 34-40 are semicolon delineated and tab delineated data made available by the government source that is deconstructed or otherwise converted to a text form and compiled into a logical retrieval system, for example a computer program such as a spreadsheet, as best illustrated in FIG. 4. In alternative embodiments, the semicolon delineated and/or tab delineated data are converted into text and electronically deconstructed, re-ordered, and compiled into a logical retrieval system. In any regard, the computer program described below is operable to manipulate the newly compiled data such that an interactive, predictive, and more useful picture of voter tendencies is constructed.

FIG. 4 illustrates a computer program 50 operable on a computer-readable medium and having computer-executable instructions useful in guiding election campaign efforts according to one embodiment of the present invention. The historical election data have been imported from fields 34-40 (FIGS. 2-3), converted into a useful text form, and input into datasets of cells (in cells located in columns A-AR and rows 1-50 at least, for example) within one or more dimensions/sheets 51 of a multi-dimensional computer program 50. With regard to “sheet 3” in the computer program 50, in one embodiment at least two interactive databases 52a and 52b are provided that correspond to, and include all precinct data, for example, from two separate prior elections (e.g., the presidential election of 2004 and the interim election of 2002, respectively). The data from the two prior elections contained within databases 52a and 52b are available for manipulation and filtering by a user of the computer program 50.

In one embodiment, the computer program 50 is a spreadsheet application including multiple spreadsheets 51 (sheet 1, sheet 2, . . . and others) that are electronically coupled to form the multi-dimensional computer program 50. With this in mind, FIG. 4 illustrates a view of one dimension/sheet 51 (i.e., “sheet 3”) of the computer program 50, although it is to be understood that the computer program 50 can have multiple dimensions and multiple electronically connected spreadsheet applications.

In one embodiment, the interactive databases 52a and 52b include and electronically communicate with the historical voter data collected for each of the elections in 2002 and 2004. The interactive databases 52a and 52b provide an interface that enables a user to observe the results of filtered queries submitted to the program 50.

The computer program 50 includes an array 53 of operand manipulative cells (OMC) 54, 56, 58, 60, 62, 64, 66, 68, 70, 72, 74 and 76 (hereafter, “the array 53”) that electronically communicate with the databases 52a, 52b and the historical election data formatted into the program 50, and are operable to calculate or otherwise produce a subset of synthesized voter data that is compiled on a second level that is derived from the historical election data.

In addition, the computer program 50 includes filter functions 55, 57, 59, 61, 63, 65, 67, 69, 71, 73, 75 and 77 that correspond to a respective one of the OMC in the array 53 described above. The filter functions (identified by odd numbers 53-77) provide various search features and filter features that enable a user of the computer program 50 to interrogate the historical voter data extracted from the source (and electronically embedded in the program 50) to derive or otherwise calculate targeted information that is compiled at a desired level (i.e., precinct level up to state level), depending upon the selected filter function 53-77.

For example, in one embodiment the filter functions 55, 57, 59, 61, 63, 65, 67, 69, 71, 73, 75 and 77 include a variety of mathematical operators and filters that are user selected, including, for example, filters for filtering “All,” “Top 10,” and “Custom” data entries in any one or all of the respective OMC 54. In one embodiment, the “Custom” filter function provides filtering operators that filter according to the data being in a state that: “equals,” “does not equal,” “is greater than,” “is greater than or equal,” “is less than,” “is less than or equal,” “begins with,” “does not begin with,” “ends with,” “does not end with,” “contains,” “does not contain,” etc. Other suitable text and mathematical operators are also acceptable and within the scope of this invention.

A separate set 80 of operand manipulative fields is provided that enables a user of the computer program 50 to input variables for estimated voter turnout, estimated total votes and estimated vote percentage, a desired target number of votes that electronically communicate with the array 53 of operand manipulative cells. As a point of reference, set 80 represents actual voter turnout and votes cast in the 2004 presidential election, although set 80 can be selectively varied to predict how past voters will vote in future election by manipulating the voter turnout variable, for example. In this manner, by selecting variables in the set 80 and filtering with filter functions 53-77, a user of the computer program 50 can manipulate the voluminous converted historical data set into a useable synthesized set of voter data compiled at a range of desired levels. In this regard, set 80 is referred to as a predictive set of fields, which is responsive to filtered queries submitted to the formatted historical data.

OMC 54 provides searchable and filterable data compiled on a municipality level. For example, in one embodiment OMC 54 provides data for all municipalities in state S as represented by municipalities 54a . . . 54aᵢzⱼ.

OMC 56 provides searchable and filterable data compiled on a county level. In one embodiment, all votes cast in all counties of state S are entered into the database and represented by counties 56a . . . 56aᵢzⱼ.

OMC 58 provides searchable and filterable data compiled on a precinct level. In this regard, OMC 58 represents tallied votes cast in all precincts as collected by the source and formatted in accordance with the present invention. The actual number of votes cast appears in OMC 76. In one embodiment, the precincts can be filtered to produce all precincts within a specific county, or alternatively, all precincts in state S.

OMC 60 provides searchable and filterable data compiled on a congressional district level. OMC 60 includes votes cast by voters in each congressional district. OMC 62 provides searchable and filterable data compiled on a legislative district level. OMC 62 includes votes cast by voters in each legislative district.

OMC 64 provides all votes cast by precinct (as filtered) for candidate X2, and OMC 66 provides the percentage of votes cast for candidate X2.

OMC 68 provides all votes cast by precinct (as filtered) for candidate X3, and OMC 70 provides the percentage of votes cast by precinct for candidate X3.

OMC 76 provides the total actual number of votes cast, and OMC 72 and 74 provide variable target numbers useful in predictive modeling of the number of votes required from any one precinct, for example, in order to meet a desired vote percentage level with that precinct by candidate. OMC 76 is filtered via filter function 77 to show all actual votes tallies greater than 1000, for example, which usefully filters out the smaller voting precinct (less than 1000 votes cast).

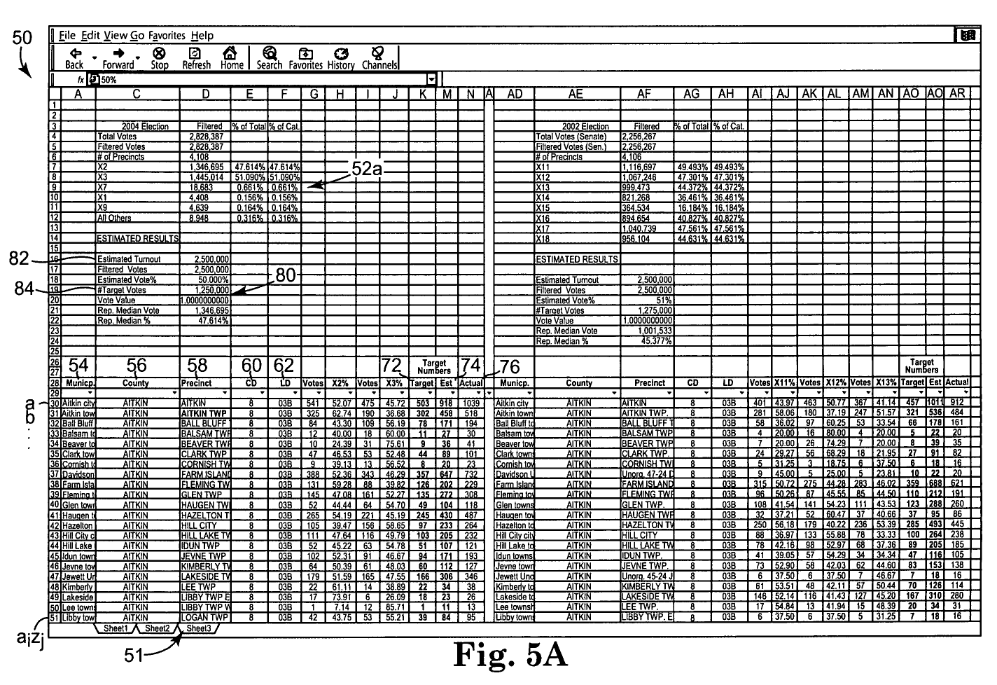

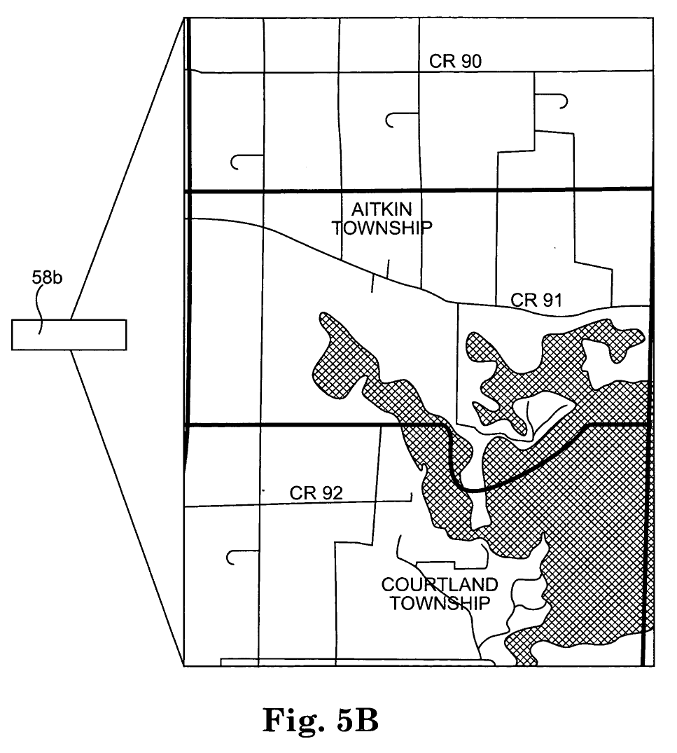

FIG. 5A illustrates computer program 50 according to another embodiment of the present invention. As a point of reference, set 80 is shown to selectively model a predicted estimated turnout 82 of 2,500,00 voters in a modeled election, such that the votes OMC 54-76 correlate to this selected estimated turnout 82. In this manner, a user can model “what if” scenarios by varying the estimated turnout 82 and number (#) target votes 84. The number of target votes 84 is set at 1,250,000, which represents half of the estimated turnout 82. In this regard, an election campaign that achieves garnering half the votes cast can be reasonably likely to succeed in the election.

OMC 58b, correlating to Aitkin Township, is illustrated as highlighted to indicate a selection of that operand manipulative cell by a user. In this exemplary embodiment, the user has chosen OMC 58b, the selection of which results in a hyperlink to a map of boundaries of Aitkin Township relevant to data within the cell. The hyperlink can link to other data representations other than maps.

FIG. 5B illustrates a mapping function of computer program 50 according to another embodiment of the present invention. With reference to FIG. 5A, the mapping function embedded in OMC 58b is executable to selectively map data electronically coupled to OMC 58b. In one embodiment, the mapping function can be embedded in any one of the array 53 of OMC and is executable to selectively map a subset of synthesized voter data. For example, in one embodiment the mapping function produces a hyperlink to a geographical map having boundaries that correlate to a level to which data in OMC 58b has been filtered, which in the exemplary case is the precinct level. In other embodiments, the mapping function hyperlinks to a bar graph or other representation of calculated and/or charted data. For example, in some embodiments the mapping function hyperlinks a bar graph of a percentage of votes tabulated for a given candidate in a given municipality (i.e., the mapping function is embedded in one of the OMC 54 cells).

With reference to FIGS. 4 and 5A-5B, in one embodiment the OMC of the array 53 are compiled to correlate to a similar level (i.e., a precinct level) of field 38 (FIG. 3) as collected originally by the source and beneficially formatted by the computer program 50. In addition, the OMC of array 53 can be compiled to represent data from regions larger than the level of field 38, such as synthesized county data compiled in OMC 56 and/or synthesized municipality data compiled in OMC 54. To this end, the computer program 50 provides a microscopic view of actual ballots cast (for example, as available in OMC 58 at the precinct level) and a macroscopic view of actual ballots cast (for example, as available in OMC 54 at the municipality level). In this regard, OMC 54 compiled at the municipality level is “larger,” or integrated, relative to the level at which the voter data was collected by the source (the precinct level) as illustrated in field 38. To this end, each of the OMC in the array 53 can be selectively manipulated (queried) to permit data analysis and extraction across a wide range of statistical variables of interest.

With additional reference to FIGS. 4 and 5A, the computer program 50 includes a predictive field in set 80 having a plurality of variables that enables a calculation of an estimated number of future voters (estimated turnout 82) and the number of target votes 84 desired to achieve success. The calculation of future vote data is based upon the actual ballots cast in the historical data, and is a function of, for example, predicted voter turnout, party affiliation of past voters, and candidate name. In this manner, an election campaign interrogates historical data from actual ballots cast in a previous election, and the computer program 50 guides present and future campaign efforts by filtering the historical data to produce a target of a desired number of voters to be reached based upon the estimated votes to be cast in any given region.

In an exemplary embodiment of precinct targeting, the 2004 election in state S had a voter turnout of 2,828,387 voters with 47.614% of voters voting for candidate X2 (See interactive database 52a FIG. 5A). In a future election, as illustrated in the predictive field of set 80, an estimated (lower) voter turnout of 2.5 million is predicted and candidate X2 (a republican, for example) projects an estimated need of 50% of the voter turnout in order to be elected. Under these predictive scenarios, OMC 72 calculates target numbers of actual votes required to be garnered by the candidate to achieve 50% of the estimated voter turnout by municipality and county and precinct (See column K). For example, in the municipality of Aitkin in the county of Aitkin in the precinct of Aitkin 1,039 actual voters voted in the 2004 election, and an estimated 918 voters will vote in a future election (OMC 74a) when the estimated voter turnout for the total state is slightly lower (2.5 million) than the actual voter turnout in the 2004 election. To this end, the targeted number of votes in the Aitkin precinct is 503. That is to say, with a 50% estimated vote goal in a future election having a slightly lower turnout, candidate X2 should target Aitkin precinct for 503 votes available votes, based on how the electorate voted in Aitkin precinct in the 2004 election. Thus, with knowledge of the historical number of votes cast for a republican candidate in Aitkin precinct in a prior election, the X2 campaign will be appraised of resources required in Aitkin precinct to gather 503 votes in a future election. In this manner, a campaign can target where resources are spent to most effectively guide campaign efforts to persuade the targeted voters to vote, thus resulting in campaign success.

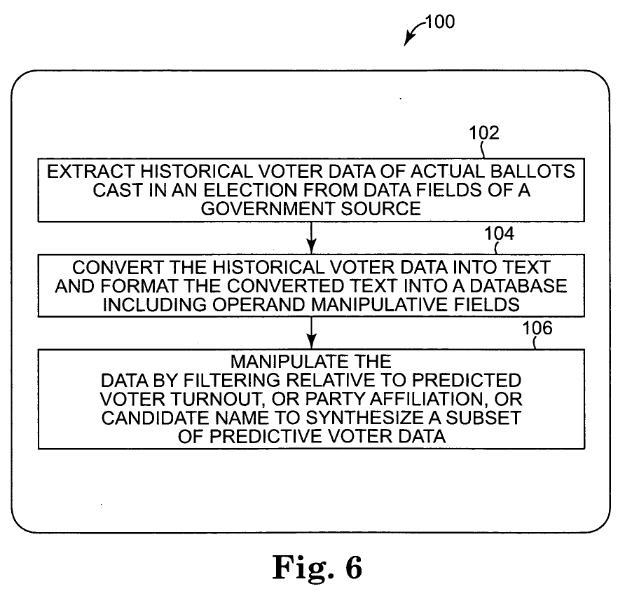

FIG. 6 illustrates a flow diagram of an algorithm 100 for guiding election campaign efforts according to another embodiment of the present invention. The algorithm 100 in one embodiment provides at 102 extracting historical voter data, at 104 converting the historical voter data into text and formatting the converted data into a database having operand manipulative fields, and at 106 manipulating the data. In one embodiment, the formatted historical voter data are manipulated by filtering the database by one or more variables that include: predicted voter turnout, party affiliation, and/or candidate name to synthesize a subset of voter data that can be employed to predict future voting tendencies. In this regard, the future voter tendencies can be compiled on levels ranging from the microscopic (precinct level) up to macroscopic (city or municipality level).

In facilitating the synthesis of voter data that is useful in future election campaigns, in one embodiment the OMC in the array 53 (FIGS. 4-5B) provide a wide range of statistical/mathematical functions including data sorting, ascending/descending functions, arithmetic operators such as “greater than” and “less than,” data filtering, summation, multiplication, division, and other suitable data analysis functions.

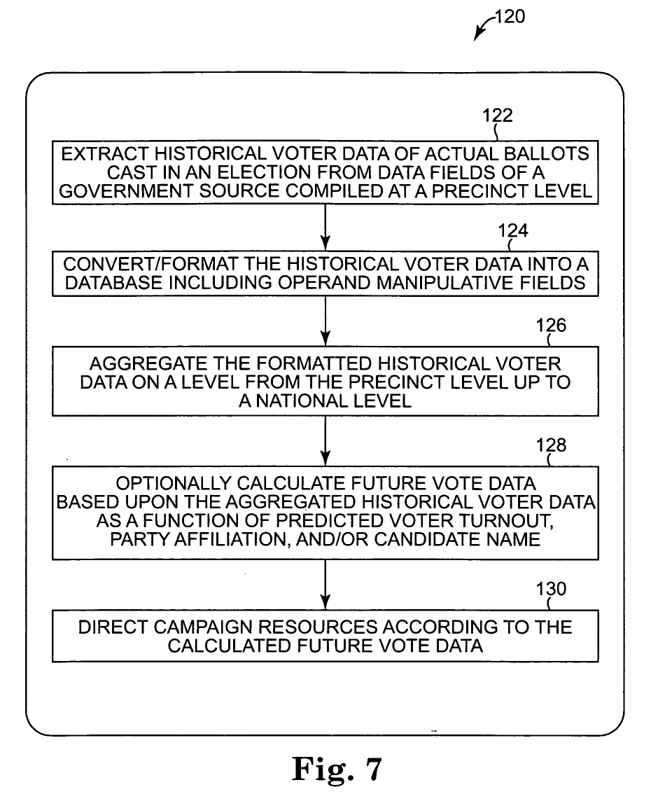

FIG. 7 illustrates flow diagram of an algorithm 120 for guiding election campaign efforts according to another embodiment of the present invention. In one embodiment, the algorithm 120 includes at 122 extracting historical voter data, at 124 converting/formatting historical voter data, at 126 aggregating the formatted historical data, optionally at 128 calculating future vote data, and at 130 directing campaign resources according to the calculated future vote data.

In one exemplary embodiment, process 122 provides extracting historical voter data of actual ballots cast in an election from data fields of a government source compiled at a precinct level. Process 124 provides converting/formatting historical voter data into a database including operand manipulative fields. Process 126 provides aggregating the formatted historical voter data on a level from a precinct level up to a national level. Process 128 provides optionally calculating future vote data based upon the aggregated historical voter data as a function of, for example, predicted voter turnout, party affiliation, and/or candidate name. Process 130 provides optionally analyzing the calculated future vote data via a variable capability arithmetic logic circuit, such as provided by a filtering OMC in the array 53 (FIGS. 4-5B).

With regard to the algorithms 100 and 120, these and other components of the present invention can be implemented in hardware via a microprocessor, programmable logic, or state machine, in firmware or in software with accessed by an electronic device, such as a computer, or in web-based software. Components of the present invention may reside in software on one or more computer-readable mediums, such as floppy disks, hard disks, CD-ROMs, portable flash memory drives, read-only memories (ROM) and random access memories (RAM).

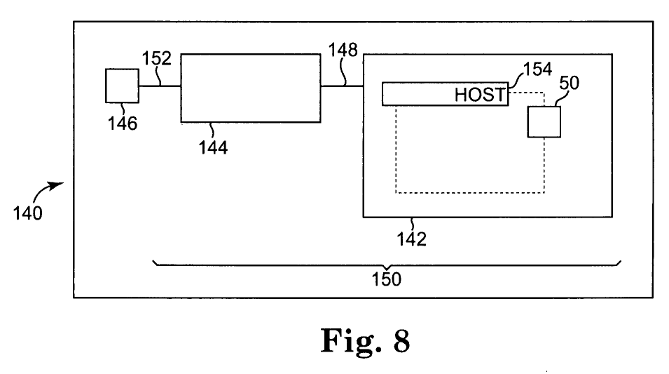

FIG. 8 illustrates a system 140 of guiding election campaign efforts according to one embodiment of the present invention. The system 140 includes a server 142, a client program 144, and an electronic device 146 having access to the client program 144. In general, the server 142 and the client program 144 communicate via a connection 148 and form a client-server system 150. When a user of the electronic device 146 accesses the client-server 150 system via an access connection 152, the client server system 150 enables interaction with the data retrieval system/computer program 50.

In one embodiment, the server 142 resides on a site of a distributed communication system, and is a program that responsively interacts with the client program 144. The server 142 includes a host 154 providing access to the computer program 50. In one embodiment, access to the computer program 50 is gained via registering through the host 154 and is fee-based.

In one embodiment, the client program 144 is a program that resides at a site on the distributed communication system and is configured to query a separate program at a separate site (for example, the host 154) on the distributed communication system. In this regard, the client program 144 is requesting program configured to “talk” to the server 142.

The electronic device 146 can be any device configured to access the client program 144. For example, the electronic device 146 can include, but is not limited to, a computer, a personal data assistant such as a Blackberry, a cellular phone having internet access, or any other device having access to the World Wide Web (i.e., a hypermedia interface for viewing and exchanging information represented as www). To this end, in one embodiment connection 152 is an internet web connection operable through a browser. With this in mind, connection 152 can include hardwired connections, or alternately wireless connections, between the electronic device 146 and the client server system 150.

In one embodiment, the computer program 50 is a program operable by computer system device 146. In this regard, the program 50 includes at least one operand manipulative field and/or OMC, such as OMC in the array 53 (FIGS. 4-5B), and includes formatted historical voter data compiled from fragmented text of actual ballots cast in an election from a government source.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A computer-readable medium having computer-executable instructions useful in guiding election campaign efforts, the computer-readable medium comprising:
vote data of ballots cast in an election collected from at least one data source, the vote data compiled on a first level;
a database including at least one dataset of cells formatted to include the vote data compiled on the first level; and
an array of operand manipulative cells electronically communicating with the database that are operable to produce a subset of synthesized vote data compiled on a second level that is derived from the vote data compiled on the first level.

2. The computer-readable medium of claim 1, wherein the vote data compiled on a first level include all counted votes cast at a precinct level, and the subset of synthesized vote data compiled on a second level includes a filtered subset of synthesized vote data that is electronically searchable and compiled on at least one of a precinct level, a municipality level, a legislative district level, a county level, a congressional district level, a state level, and a national level.

3. The computer-readable medium of claim 2, wherein the filtered subset of synthesized vote data are filtered for precincts in which a party candidate receives at least 50% of the votes cast.

4. The computer-readable medium of claim 1, wherein the vote data resides on a first spreadsheet of a computer program, and the database and the array of operand manipulative cells reside on a second spreadsheet of the computer program, the first spreadsheet electronically linked to the second spreadsheet.

5. The computer-readable medium of claim 1, further comprising:
a mapping function that is executable to selectively map the subset of synthesized vote data on a geographical map having boundaries that correlate to the second level.

6. A method of guiding election campaign efforts comprising:
extracting voter data collected from actual ballots cast in an election and disseminated by a data source, the voter data including votes compiled on a first level;
formatting the votes compiled on the first level into at least one dataset of cells within a database; and
electronically manipulating the at least one dataset of cells with an array of operand manipulative cells to produce synthesized voter data compiled on a second level that is at least as large as the first level.

7. The method of claim 6, wherein extracting voter data includes:
extracting a delineated file of historical voter data collected from actual ballots cast in an election and disseminated by a government data source; and
converting the delineated file to a text file.

8. The method of claim 7, wherein extracting a delineated file includes extracting at least one of semicolon delineated text and tab delineated text from a file of actual ballots cast in an election and disseminated by a secretary of state.

9. The method of claim 6, further comprising:
predicting future voting data by filtering the synthesized voter data as a function of at least one of predicted voter turnout, party affiliation, and candidate name.

10. The method of claim 9, wherein predicting future voting data includes targeting a number of votes to be captured in a precinct by a candidate as a function of previous votes cast in that precinct.

11. The method of claim 6, wherein the first level is a precinct level, and the second level is one of a precinct level, a municipality level, a legislative district level, a county level, a congressional district level, a state level, and a national level.

12. The method of claim 6, wherein formatting the votes includes converting delineated precinct vote data into text precinct vote data and entering the text precinct vote data into at least one searchable dataset of cells within a database.

13. The method of claim 6, wherein electronically manipulating the at least one dataset of cells includes spreadsheet linking the at least one dataset of cells with the array of operand manipulative cells.

14. The method of claim 6, wherein the vote data points are compiled at a first level on a first spreadsheet in a computer program and the synthesized voter data are compiled on a second level in one of the first spreadsheet and a separate second spreadsheet of the computer program, the first spreadsheet electronically linked to the second spreadsheet.

15. The method of claim 6, further comprising:
mapping the synthesized voter data on a geographical map having boundaries that correlate to the second level.

16. An election campaign management system comprising:
a computer system; and
a program operable by the computer system, the program including:
historical data of votes cast by precinct in an election collected from a data source,
a database including at least one dataset of cells formatted to include the historical data of votes cast by precinct,
an array of operand manipulative cells electronically communicating with the database that are operable to produce a subset of synthesized voter data compiled on a second level that is derived from the historical data of votes cast by precinct.

17. The election campaign management system of claim 16, wherein the program operable by the computer system includes a target function that filters the synthesized voter data to calculate a future voting pattern for the precinct as a function of predicted voter turn out.

18. The election campaign management system of claim 16, wherein the program operable by the computer system includes a mapping function that hyperlinks to a map having boundaries that correlate to the second level.

19. The election campaign management system of claim 16, wherein the program operable by the computer system is Internet accessible.

20. The election campaign management system of claim 16, wherein the program operable by the computer system includes a computer-readable compact disk.
